(19) United States
(12) Patent Application Publication
(10) Pub. No.: US 2001/0034746 A1
(43) Pub. Date: Oct. 25, 2001

(54) Methods and systems for creating user-defined personal web cards

(76) Inventors: Alex Tsakiris, Del Mar, CA (US); John B. Watson, San Diego, CA (US)

Correspondence Address: Rosemarie F. Jones, Esq., Heller Ehrman White & McAuliffe, LLP, 275 Middlefield Road, Menlo Park, CA, 94025-3506, US

(21) Appl. No.: 09/792,233

(22) Filed: Feb. 23, 2001

Related U.S. Application Data
(60) Provisional application No. 60/185,350, filed on Feb. 26, 2000.

(51) Int. Cl. G06F 17/21

(52) U.S. Cl. 707/517

(57) ABSTRACT

The invention relates to creating a set of user-defined personal web cards thereby facilitating access to resources on the Internet while using a mobile device, particularly a mobile phone. The invention enables a user to enter or provide configuration information, which defines one or more personal web cards. Based on such configuration information, personal web cards are generated. This generation may be done after the configuration information has been entered or when a user request is received. The invention then enables users of mobile devices to send requests for predefined personal web cards. The personal web card requested is then presented or displayed on a mobile device, thereby enabling that user of that mobile device to obtain information or access an Internet resource by simply selecting one of the options contained in the personal web card. The cumbersome manner of input for mobile devices is ameliorated.

This application claims priority to co-pending U.S. Provisional Patent Application 60/185,350, entitled “Methods and Systems for Creating User-Defined Menus that are Read by Wireless Devices and a Method for Accessing Web Sites by Selecting Menu Option Items from User-Defined Menus” by Alex Tsakiris and John B. Watson, filed Feb. 26, 2000. Priority of the filing date of Feb. 26, 2000 is hereby claimed, and the entire disclosure of said Provisional Application is hereby incorporated by reference.

### FIELD OF INVENTION

This invention relates generally to creation of web cards, particularly web cards read and used by mobile devices.

### BACKGROUND

An Internet web site generally comprises a hierarchical structure of connected web pages. A web page is connected to other web pages by hyperlinks contained on or embedded on the forwarding page. Hyperlinks are elements in a web page, such as one or more words, phrases, symbols, or images that enable a user to view another web page by clicking on such hyperlink. Some web pages, however, may be unconnected to other web pages, i.e., they do not contain any hyperlinks. To access the “deepest” (last) web page in a hierarchy of web pages, a user may have to click on a number of hyperlinks to get to the deepest page on the hierarchical web site structure.

FIG. 1 shows a conventional web site hierarchical structure. To access a web page on a web site, a user typically begins by accessing the starting page or home page 100. The home page 100 generally contains hyperlinks to other web pages giving the user the option to view other web pages. To access Page D 150, for example, the user clicks the hyperlink to Page C contained in the home page 100. Once the user clicks on that hyperlink, Page C 115 is loaded onto the user's Internet browser for the user to view. The user then clicks on the hyperlink to Page C1 145 contained in Page C 115. The browser then loads Page C1 145. To access Page D 150 the user must finally click on the hyperlink to Page D contained in Page C1 145. Thus, to get to Page D 150 the user must click on several hyperlinks and, load and view several web pages. A user, however, may also access Page D 150 directly by typing in the Uniform Resource Locator (URL) of Page D. A URL is a specific address for a resource, such as a web page on the Internet.

Web pages are generally designed to be accessed by desktop computers, which typically have high-resolution monitors and full-size keyboards that contain alphanumeric keys and special command keys for carrying out specific tasks, such as the F1 key for help. Mobile phones, personal digital assistants (PDAs), and other small form factor microprocessor based devices like hand-held computers, on the other hand, do not have high-resolution monitors or full-size keyboards. Generally, these communications/scheduling devices have a small screen or monitor and, in the case of mobile phones, limited sets of keys to control their operations are available. Furthermore, input of alphabetic characters usually involves using the available limited set of keys in a cumbersome manner, such as tapping the number “2” key twice to input a letter “B” or tapping the “7” key three times to input a letter “S.” Typing the URL address of a specific web page into the web browser of these small units thus can prove to be very time consuming. Accessing or navigating the hierarchical structure of a web site to access a particular web page also involves unnecessary loading and viewing of web pages and pressing (or tapping) of keys.

To connect to the Internet, a computer user typically needs to sign up with an Internet Service Provider (ISP), such as AOL or EARTHLINK®. The ISP provides the computer user the connection to the Internet. Hypertext Transfer Protocol (HTTP) is generally the protocol used by computers to access the Internet. Using HTTP, browsers may access the Internet and read web pages that are supported and readable by HTTP. Examples of such web pages are files written using the Hypertext Markup Language (HTML), Extensible Markup Language (XML), Extensible Stylesheet Language (XSL), and the like.

Mobile or wireless devices, such as wireless mobile phones, also connect and access the Internet. Similar to computer users, mobile users also need to sign up with a wireless network provider, such as SPRINT and AT&T, to connect to the Internet. Wireless Application Protocol (WAP) is the protocol typically used by mobile devices to access the Internet. Using WAP, browsers on a mobile device may request and read web pages on the Internet. Examples of such web pages are files written in the Wireless Markup Language (WML). WML, similar to HTML, is a markup language used to write web pages on the Internet. Some mobile phones also contain browsers that are capable of reading HTML, HDML (Handheld Device Markup Language), XML, and the like. Thus, it is possible that files or resources on the Internet are available for both mobile devices and computers to read or display. WAP is a standard for communications between a mobile device and the Internet or other computer applications.

To distinguish web pages read by computers from web pages read by mobile devices (e.g., mobile phones), web pages that are typically read by mobile devices are herein referred to as “web cards”, and “web pages” herein refer to documents that are typically read by computers.

Some mobile phones with displays have menus that list options for setting-up and retrieving basic information. These menus are usually set-up for the convenience of users and may be displayed by the user pressing the “SELECT” key or other similar keys (for example, pressing the “MENU” key, then scrolling to a selection and touching the “SELECT” key or “DISPLAY” key.). A menu is effectively a web card set up to represent a list of options from which the user may choose.

There are several known ways of implementing menus on mobile phones. Two common ways are through static and dynamic web card-based menus.

Static web card-based menus involve the user selecting a menu item, which results in certain data being retrieved from the mobile phone's memory. The list of menu items/options is typically predetermined by the phone manufacturer. Data stored related to a menu option are displayed when a key or a set of key sequences (ex. “SELECT” key) is pressed. However, before a user may make any selection, the user has to set-up the menu options and store data in the mobile phone's memory. Data stored may include phone numbers, links to another set of menus (sub-menus), commands (such as command to run an Internet browser), and the like.

To store these data in memory, the mobile phone is set into a mode for receiving user input for a selected menu option (e.g., scrolling to “Phone Book” and pressing the SELECT key). Pressing the “8”, “8”, “6”, “4”, “3”, “3”, “2” keys in sequence, for example, stores the “8864332” phone number into the mobile phone's memory. When the user wants to retrieve and use these data, certain keys must be pressed to retrieve the “8864332” data.

Dynamic web card-based menus are menus typically generated by a web server using/reading information from a database on a computer network (e.g., the Internet). The web server, via a program, formats this information into a web card. This is implemented by first running the browser software in the mobile phone memory (such as by pressing a browser-designated key on the keypad). The browser then requests the dynamic web card-based menu from a web server, which in turn reads information from a database. A web card is then created from such database information by the server, and passed back to the user's browser. The created web card contains menu options, such as links (hyperlinks) to other web cards on the Internet, submenu lists, and the like.

Databases used to generate dynamic web card-based menus are generally created by parties other than the mobile user and hence tend to be generic; that is, they are designed to provide a web card for the “average” mobile user. Hence, some menu options provided are those that are not needed by the mobile user. Furthermore, a user presently cannot design personal web cards or make changes to these databases. For example, if “WEATHER” is a menu item, trying to get a three-day weather forecast for a particular city, such as Boston, may involve navigating through some menus and submenus and keying the city name or zip code (as input parameter to a web card) by tapping the keys on the mobile phone. There is currently no easy way to create personalized web cards tailored to the needs of a user.

Thus, there is an unmet need for an easier and faster way of accessing web cards or resources on the Internet by users of mobile devices rather than by navigating through the hierarchical structure of a web site or by the cumbersome keying-in of the entire URL address string into a browser's address box. The present invention fulfills this need and the other shortcomings described above.

### SUMMARY OF THE INVENTION

The invention relates to creating a set of user-defined personal web cards thereby facilitating access to resources on the Internet while using a mobile device, particularly a mobile phone. The invention enables a user to enter or provide configuration information, which defines one or more personal web cards. Based on such configuration information, personal web cards are generated. This generation may be done after the configuration information has been entered or when a user request is received. The invention then enables users of mobile devices to send requests for predefined personal web cards. The personal web card requested is then presented or displayed on a mobile device, thereby enabling that user of that mobile device to obtain information or access an Internet resource by simply selecting one of the options contained in the personal web card. The cumbersome manner of input for mobile devices is ameliorated.

In one aspect, the invention provides a method of creating a set of one or more personal web cards by a user to be used or read by mobile devices. In the first operation, configuration information is received from a user to define one or more personal web cards. Next, this configuration information is stored in a data store. Optionally, a request for one of the defined/predefined personal web cards is received from a mobile device. Once this request is received, the requested personal card may then be generated based on the stored configuration information. The requested personal card may optionally then be presented on the mobile device.

In another aspect, the invention provides for a software program product that is capable of executing the method and features described above when loaded and executed, for example, in a computer. In another aspect, the invention provides for an apparatus capable of executing the method and features described above.

In another aspect, the invention provides another method of creating a set of one or more personal web cards by a user to be used or read by mobile devices. In the first operation, configuration information is received from a user to define one or more personal web cards. Next, one or more personal web cards are generated based on the received configuration operation. Then, these generated personal web cards are stored in a data store. Optionally, a request for one of the personal web cards is received from a mobile device. Once this request is received, the requested personal web card may optionally be presented on the mobile device.

In another aspect, the invention provides for a software program product that is capable of executing the method and features described above when loaded and executed, for example, in a computer. In another aspect, the invention provides for an apparatus capable of executing the method and features described above.

In another aspect, the invention provides a method of receiving personal web cards by a mobile device. First, the mobile device sends a request for a predefined personal web card. Next, the requested personal web card is presented on this mobile device. Optionally, a user selects one of the menu options in the requested personal web card, for example, to access an Internet resource or to access another predefined personal web card.

In another aspect, the invention provides for a mobile device capable of executing the method and features described above.

In another aspect, the invention provides for a system that enables a user to define one or more personal web cards and enables this user to request these defined or predefined personal web cards from a mobile device. The system comprises a configuration web server, which provides a configuration web site enabling user to define personal web cards by entering configuration information; a data store; a personal card generator, which generates personal web cards based on the configuration information entered by said user; and a card web server, which serves the personal web card generated.

Defining the personal web card via a web page using a computer or PDA as opposed to via the mobile phone is far easier and more efficient as compared to creating static web card-based menu options by tapping on the keys of a mobile phone. Furthermore, in the case where web cards are used as a hierarchical set of menus, customization of personal web cards enable a user to structure the set of web cards for greatest efficiency (e.g., most accessed web card menu option first and the least accessed web card menu last).

This invention thus also provides a convenient access and manipulation of information on the Internet using mobile devices. The invention also provides improved reliability and speed of accessing the correct resource on the Internet and minimize input on mobile phones by enabling requests for Internet resources be sent via personal option selections rather than through navigation of the hierarchical structure of web cards on a web site. Other features and advantages of the present invention should be apparent from the following description of the preferred embodiment, which illustrates, by way of example, the principles of the invention.

### BRIEF DESCRIPTION OF THE DRAWINGS

This invention is illustrated by way of example by the reference to the following drawings:

FIG. 1 is the hierarchical structure of a typical prior art web site.

FIG. 2 is an exemplary system embodying the features of the present invention.

FIG. 3 is a flow diagram illustrating one embodiment of the present invention.

FIG. 4 is an exemplary high level flow diagram illustrating one embodiment of creating user-defined personal web cards.

FIG. 5A is a sample configuration web site (or web page) enabling a user to create one or more personal web cards.

FIGS. 5B and 5C are exemplary web cards that may be displayed on a mobile device.

FIG. 6 is a flow diagram illustrating one embodiment of how a user accesses a personal web card.

FIG. 7 is a block diagram representation of one of the computers in the system illustrated in FIG. 2.

### DETAILED DESCRIPTION

The following detailed description illustrates the invention by way of example, not by way of limitation of the principles of the invention. This description will clearly enable one of ordinary skill in the art to make and use the invention, and describes several embodiments, adaptations, variations, alternatives and uses of the invention, including what we presently believe is the best mode of carrying out the invention.

The invention will be described by way of illustration with reference to mobile phones, but it should be understood that other devices such as phones on wire or wireless networks and other mobile devices may also be used (herein, termed generically “mobile devices” or “mobile phones”). In addition, other devices that have limited input capabilities, have limited display capabilities, or which access the Internet may also be used, such as wireless telephones, Internet access appliances, and the like. Although the user interface described refers to keys on a keypad, this invention also covers other interfaces such as those using voice, a mouse, or a touch screen. The invention also applies to protocols other than WAP and HTTP. While generally a “display” or “screen” is referred to herein for visual presentation, for example, of documents containing menus, menu items, and web pages, it should be understood that the invention covers audio presentation, including voice activation and “read-to” responses.

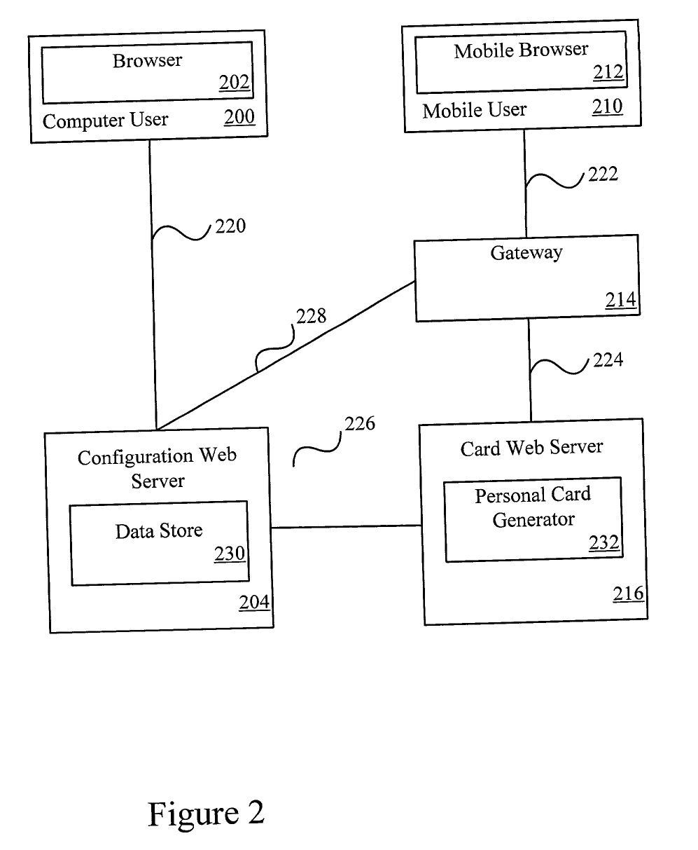

FIG. 2 is an exemplary system embodying the features of the present invention. A computer user 200, using his browser 202, accesses the configuration web server 204 via a data network 220, such as via phone lines (e.g., through modems), dedicated data lines, cellular connections, microwaves, satellite networks, the Internet, and the like. Alternatively, the computer user 200 may also access the configuration web server 204 via other Internet appliances, such as those developed by WEBTV®, which have the capability of interfacing with web pages via a full size keyboard. The computer user may also access the configuration web server 204 via a mobile device, though the interaction in this case is limited, as the user does not have a full size keyboard.

The configuration web server 204 provides configuration web pages or web site (herein referred to as a configuration web site) that enables the computer user 200 to easily define a set of personal web cards (one or more), for later use by a mobile device. The set of personal web cards may form a menu, contain user-specific information or content for display, or a combination of both. A number of these personal web cards may be interconnected, linked to each other to form a menu hierarchy, thus enabling a user to create a personalized set of web cards. For instance, a web card may contain some notes about a calendared event, name and address or other contact information, or even scattered notes that the user would like to keep. These personal web cards also provide the user the ability to jump from web card to web card and organize information in a coherent fashion.

From the configuration web site, a user defines personal configuration information (further discussed below), such as by selecting options from a list box or by entering web card content via a keyboard or other input device. The personally selected and entered information, i.e., the user's configuration information, is stored in a data store 230. This data store may be contained in the configuration web server 204, in the card web server 216, or in both. (For illustration purposes only, it is part of the configuration web server 204).

In one embodiment, personal web cards are dynamically generated and stored in the data store 230. The personal card generator 232 generates the user-defined personal web cards based on the configuration information provided by the user, which is usually read from the data store 230. The personal card generator 232 may be part of the configuration web server 204, card web server 216, or both. For illustration purposes only, it is part of the card web server 216. (A web server is a software or device that serves or makes available resources, data, or files to users.) These generated personal web cards and the configuration information are then stored in the data store 230. Typically, the configuration information is stored in the configuration web server 204, e.g., in a database to enable the user to easily make modifications to the configuration information at a later time. (The card web server 216 is a web server that serves cards.)

In another embodiment of the invention, only the configuration information is stored in the data store 230, i.e., no personal web cards are stored. The personal card generator 232 using the configuration information stored in the data store 230, dynamically generates a personal web card on demand, i.e., upon user request, and typically using a script (a program) and a web server software. In the preferred embodiment, the web cards are written using the WML syntax. Other markup languages used to create web cards, such as HDML, may also be used.

The following describes how users may read their personal set of web cards from their mobile devices.

The mobile user 210 using a mobile browser 212 is connected to the gateway 214 via a data network 222, particularly, a wireless data network. A gateway is a server (software or device) which acts as an intermediary for some other server. In this embodiment, it passes/sends requests and responses to and from the mobile browser 212 via the wireless data network 222. In addition, it may also pass/send requests and responses to the configuration web server 204 and to the card web server 216. The gateway 214 is also connected to the card web server 216 via a data network 224, typically, through the Internet. It may also be connected to the configuration web server 204 via a data network 228. The card web server 216 is further connected to the configuration web server 204 via a data network 226. Alternatively, the card web server 216 and the configuration web server 204 may reside in one computer, reducing network transmission.

The card web server 216 via the gateway 214 receives a mobile user's request for a predefined personal web card. The gateway receives the WAP request from the mobile browser 212 and converts it into a format or structure that can be understood by the card web server 216, i.e., converts it into an Internet request. (A WAP request herein is a request from a mobile device for a resource or resources on the Internet. The request is usually coded.) The gateway 214 then sends this Internet request to the card web server 216, which in turn sends an Internet response back, containing the requested predefined personal web card. The response is in the form of a personal web card. (The card web server 216 retrieves the generated and stored personal web card from data store 230 or dynamically generates on demand the personal web card using the configuration information stored in the data store 230 via the personal card generator 232.) The gateway 214 then converts the Internet response received into a format that is understood by the mobile browser 212 (or the mobile device). Internet requests and responses between the gateway and the card web server are typically via the Internet 224.

One of ordinary skill in the art will recognize that variations in the system may be employed, for example, the card web server 216 may also carry out the functions of the gateway 214, and the like.

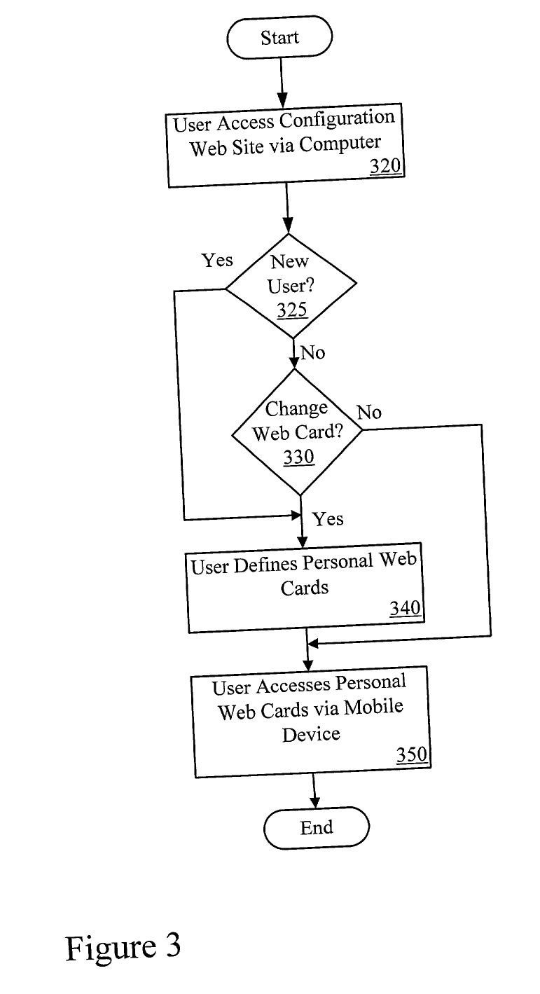

FIG. 3 is a flowchart of one embodiment of the invention illustrating the overall system and method of the invention. First 320, the user defines a personal set of web cards by accessing a configuration web site via a computer connected to the Internet and having a browser typically supporting the HTTP protocol. Another version of the configuration web site may be accessible via a mobile device, like a palm computer, connected to the Internet and having a browser typically supporting the HTTP or WAP protocol. The configuration web site (see FIG. 2, configuration web server 204) enables the user to create and define a personal set of web cards for mobile devices by enabling the user to enter configuration information (discussed in more detail below). The user may access the configuration web site by logging in using a user name and a password, thus, enabling the configuration web site to generate one or more personal web cards and/or store configuration information based on the user name.

Once the user accesses the configuration web site at operation 320, the configuration web site determines if the user is a new user 325. If the user is a new user, a “yes” outcome at the decision box 325, the user then defines personal web cards via the configuration web site at operation 340. The configuration information is typically stored in a data store, e.g., database, to enable later modifications by the user. If the user, however, is not a new user 330, a “no” outcome at the decision box 325, the configuration web site then checks if the user wants to change an existing or predefined personal web card, at operation 330. If the user decides to change a user's personal web card, a “yes” outcome at the decision box 330, the user may do so by defining (re-defining) that user's personal web card at operation 340 via the configuration web site. (Depending on implementation, this means that the user changes the options or parameters contained in the generated personal web card or configuration information). If a user desires to change an existing personal web card, the user may do so at any time by again accessing the configuration web site and then defining (re-defining) the personal web card desired. Variations on how users define or redefine personal web cards may also be implemented and are known to those skilled in the art.

Once a personal web card is defined, the user may then optionally access or request that personal web card at any time via a mobile device at operation 350. The personal web card, defined by the user via the configuration web site, is then displayed on the mobile device, particularly, the mobile browser 212 (FIG. 2). The user may also optionally select a desired menu option, such as by pressing the “SELECT” key upon scrolling to the chosen option, which may result in another predefined personal web card or another web site to be displayed on the user's mobile browser 212 (FIG. 2). The predefined personal web card may have been dynamically generated on demand or retrieved from a database.

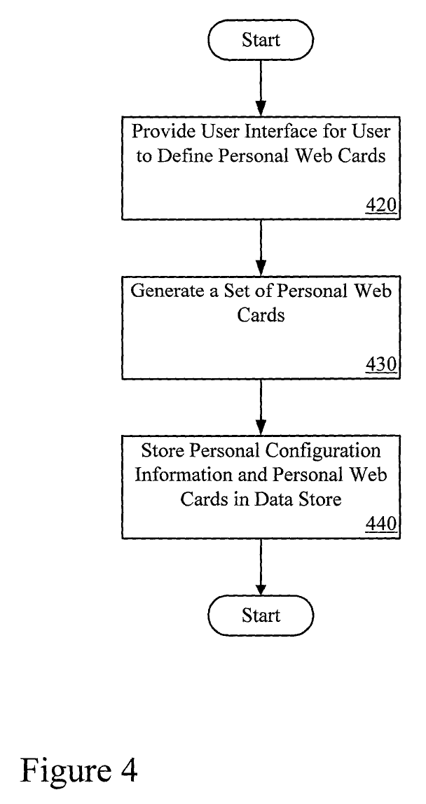

FIG. 4 illustrates one exemplary embodiment to create user-defined personal web cards. The configuration web site, in its basic form, provides a user interface that enables users to define a set of personal web cards 420 based on user inputs. Once the user finishes defining the user's set of personal web cards, the personal card generator 232 (FIG. 2) generates the actual personal web card files from the configuration information provided, at operation 430. This is implemented, for example, by having the configuration web site provide a “SUBMIT” button on the bottom of the configuration web page. Once the user is done, the user then clicks the “SUBMIT” button, initiating automatic generation of the personal web cards (e.g., by using conventional generation software tools, such as web server software and scripting languages). The generated personal web cards, of course, are based on user inputs made during the definition of the personal set of web cards.

The generated personal web cards and the underlying configuration information are stored in a data store 230 (FIG. 2), at operation 440, enabling later retrieval and modifications of the web card set. In one embodiment, the configuration information is stored in a database, which contains user names, passwords, menu options, parameters, URL addresses, and the like. In another embodiment, such information is stored in a relational database management system (RDBMS). Any other storage formats, however, that allow retrieval and modification of information, such as plain ASCII files, may also be used. The data store thus contains the personal web card definitions, i.e., the configuration information, for each personal web card defined. To facilitate user access, the configuration web site may be implemented via the Internet, such as an Internet web site, which consists of, for example, web pages and scripts. One skilled in the art will recognize that variations on how the data are to be stored and how the configuration web site works depend on system implementation and design.

In another embodiment (not illustrated) after definition of the personal web card(s) by the user via a configuration web site, only the configuration information is stored in the data store 230. Using the configuration information, the personal card generator 232 (FIG. 2) dynamically generates a personal web card only upon demand, i.e., when requested by a user using a mobile device. Using the configuration information provided by the user, a personal web card is generated and then ultimately sent to the mobile browser 212 of the mobile user 210 (FIG. 2).

In another embodiment (not illustrated), the configuration web site is a software package that is run on a stand-alone computer. In this embodiment, a user, for example, runs/executes a configuration web site program on a computer to generate personal web cards, optionally, including file(s) containing configuration information. A window interface is provided to the user to define the user's personal web card. The file(s) and the personal web card(s) may then be uploaded (sent to) the user's selected ISP or other application service provider (e.g., the cell phone service to which the user subscribes). The ISP may then serve (make available) the personal web card(s) to the user upon user's request.

The following describes the configuration web site and its use.

A configuration web server 204 via a configuration web site provides a user interface that enables a user to define a unique set of personal web cards 420. The user interface may be structured in a wide range of ways to enable the user to define a hierarchical set of personal web cards. In a first embodiment, the user is presented with a single default web card, which the user may use by “click-clicking” selected alternatives, or by modifying by data entry. A second embodiment comprises input boxes on a web page (also referred to as a “template” or “form”) in which the user directly enters data, web site input parameters, a list of favorite Internet URL addresses, or even non-hyperlink content like words or URL inclusion links for sounds, graphics, or multimedia content. In a third embodiment, icons representing or list boxes containing web sites that provide information to mobile devices may be selected by check boxes or clicking on them. In this manner personal menu options and content such as contact information, web card addresses (URLs), links to submenus, and the like are defined in the configuration web site for access by the user.

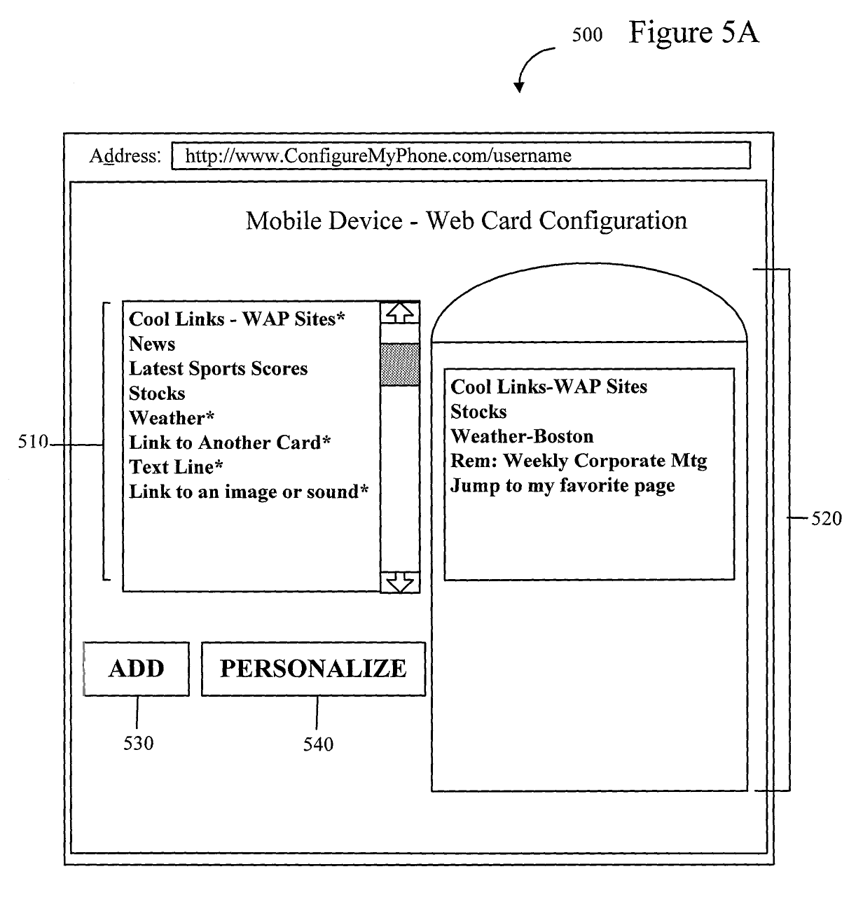

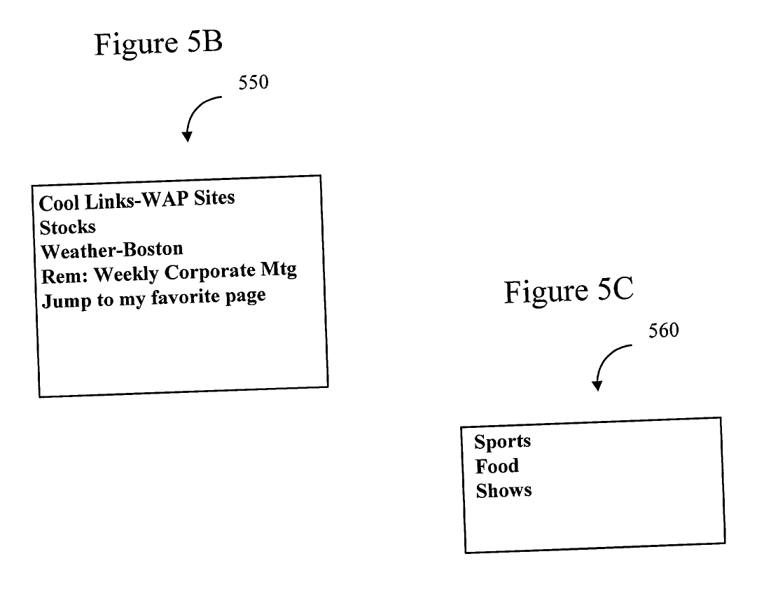

FIG. 5A is an exemplary configuration web page 500 (or web site) enabling a user to create one or more user-defined personal web cards, which are displayed by the configuration web server when accessed by a computer user 200 (in FIG. 2). In one embodiment, a user creates one personal web card at a time. A list box 510 containing possible content ideas or menu options is displayed. The computer user may select any desired option from the list box 510 by pressing the “ADD” button 530. A representation of the user's personal web card is displayed within the configuration web page, as illustrated in box 520. If a user selects one of the items such as “Cool Links-WAP Sites*” contained in the list box 510, the user may further personalize that option by selecting the “PERSONALIZE” button 540. The “*” indicates that the option can be further personalized. For example, selecting “Weather*” (from list box 510) and clicking on the “PERSONALIZE” button result in another window being displayed enabling the user to select locations of particular cities. For example, if the user selects the city “Boston”, the personal web card generated and/or the configuration information also contains the necessary parameter information such that when the user selects the “Weather—Boston” option from his mobile phone, a web card displaying weather information for Boston is displayed. If a user selects “Link to Another Card*” from the list box 510, the “PERSONALIZE” button 540 enables the user to type in a heading for that link, which is then displayed in the representation box 520. That heading, for example, may be “Jump to my favorite page” or “Rem: Weekly Corporate Mtg.” Connected to that defined link may be a specific URL address, a link to another user-defined personal web card created by the user, and the like. In another example, if the user selects “Text Line*,” the “PERSONALIZE” button 540 enables the user to enter a line of text or content to be displayed on the web card, for example, a phone number, an address, text information, and the like.

WML is a subset of the XML specification. Similar to HTML, XML is a generalized markup language. Pieces of information are delimited by start tags, e.g., “<card>,” and end tags, e.g., “</card>,” with the end tag exactly like the tart tag except a slash (“/”) precedes the tag name. Data delimited by a start tag and an end tag are generally called elements.

Table I below illustrates a set of personal web cards generated by a personal card generator of the present invention. It is written in XML and partly represents the web card defined in FIG. 5A (list box 520).

TABLE I
Sample WML File

| Line | WML Code |
|---|---|
| 1 | <?xml version=″1.0″?> |
| 2 | <!DOCTYPE wml PUBLIC ″-//WAPFORUM//DTD WML 1.1//EN″ |
| | ″http://www.wapforum.org/DTD/wml_1.1.xml″> |
| 3 | <wml> |
| 4 | <card id=″links″ title=″Personal Menu″> |
| 5 | <p><anchor>Cool Links-WAP Sites<go |
| | href=″#CoolLinks″></go></anchor></p> |
| 6 | <p><anchor>Stocks<go href=″http://wap.stocks.com″></go></anchor></p> |
| 7 | <p><anchor>Weather-Boston<go |
| | href=″http://wap.weather.com?city=Boston″></go></anchor></p> |
| 8 | <p><anchor>Rem: Weekly Corporate Mtg <go |
| | href=″http://wap.mycompany.com?id=monthlymtg″></go> |
| | </anchor></p> |
| 9 | <p><anchor>Jump to my favorite page <go |
| | href=″http://wap.myfavoritepage.com ″></go></anchor></p> |
| 10 | </card> |
| 11 | <card id=″CoolLinks″ title=″Cool Links″> |
| 12 | <do type=″prev″ label=″Back″></do> |
| 13 | <p><anchor>Sports<go href=″http://wap.site1.com″></go></anchor></p> |
| 14 | <p><anchor>Food<go href=″http://wap.site2.com″></go></anchor></p> |
| 15 | <p><anchor>Shows<go href=″http://wap.site3.com″></go></anchor></p> |
| 16 | </card> |
| 17 | </wml> |

Lines 1 and 2 indicate the version of XML and WML used (required by the WML specification). Lines 4 to 10 show a user-defined personal web card (FIG. 5B), which is the representation of the user-defined web card, as shown in FIG. 5A box 520. Lines 5 to 9 show that “Cool Links-WAP Sites,” “Stocks,” “Weather—Boston,” “Rem: Weekly Corporate Mtg,” and “Jump to my favorite page” are hyperlinks to other web cards. These hyperlinks may be to user-defined personal web cards or existing sites with specific URL address. Line 5 shows that the hyperlink “Cool Links-WAP Sites” further displays another web card with hyperlinks for “Sports,” “Food,” and “Shows” (lines 11 to 16, see FIG. 5C), which may be a user-defined personal web card. Line 7 shows that if the user clicks on the hyperlink “Weather—Boston,” a request is sent, via the gateway 214 (FIG. 2), to the “wap.weather.com” with the parameter or value “Boston.” This is indicated by “?city=Boston” string, which is part of the URL address.

Lines 11 to 16 may represent another personal web card. Those skilled in the art will recognize that variations on how to code WML files or web cards are available. For example, the card element (lines 11 to 16) identified as “CoolLinks” (line 11, “id=Cool Links”) may be coded in another WML file rather than in another card element in the existing WML file.

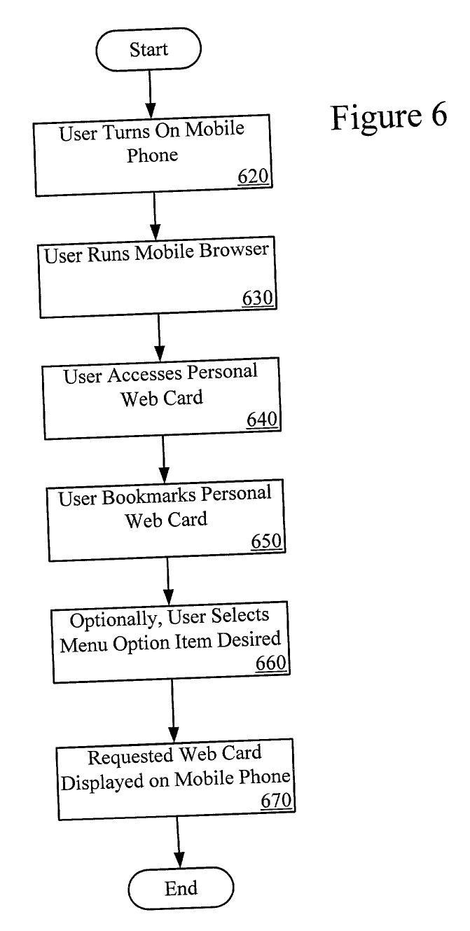

FIG. 6 illustrates an exemplary way to enable a user to access Internet URLs, retrieve data, or go directly to a web card by simply pressing one or a few keys and without cumbersome keying on the mobile phone's or device's keypad.

The first operation 620 in this method is for the user to turn on the mobile phone. The next operation 630 is for the user to run the mobile browser available on the mobile phone. The user then requests or accesses a user-defined personal web card, which acts as a starting web card or home card (e.g., similar to a home page). This is done by typing the URL address of the personal home web card in the browser's address box, e.g., typing in “www.ConfigureMyPhone.com/username.” The card web server 216 (FIG. 2) based on the URL address, for example, knows which appropriate personal web card to retrieve or knows which appropriate configuration information to retrieve to generate the requested personal web card. (Although keying in the URL of the personal web card may be cumbersome, this only needs to be done once since this address is bookmarked.) The WAP request for the personal web card is then sent to the card web server 216 via the gateway 214, which translates the WAP request to a format recognizable by the card web server. The response, i.e., the personal web card, returned and received by the gateway in turn is then translated into a format recognized by the mobile device. The personal web card requested by the user is then displayed on the screen of the mobile device at operation 640.

The next operation 650 is for the user to bookmark the home personal web card address in the mobile browser 212. (To bookmark a web card means to create a link to that web card thus enabling a user to return to it later by selecting the created link.) The user may then optionally select a menu option from the personal web card displayed by tapping one or a few keys, rather than typing in the URL address. For example, instead of typing in “http://wap.stocks.com,” the user just scrolls to and selects the desired menu option, e.g., Stocks (see FIG. 5B and Table I), at operation 660 by pressing a key on the keypad such as a “SELECT” key (similar to selecting a hyperlink on a web page). Upon selecting the menu option, the requested Internet resource is then displayed on the mobile phone's screen via a web card at operation 670.

Table II below is another example of a user-defined personal web card displayed on a mobile phone's screen or browser.

TABLE II

Mr. Smith's Phone
Menu for Fun Stuff

For example, once the user selects “Mr. Smith's Phone” option, another web card containing “987-9898” (phone number of Mr. Smith entered by the user via the configuration web site) is displayed on the screen of the mobile phone. The web card may also be set-up such that selecting the menu option “Mr. Smith's phone” automatically dials the phone number stored under this option.

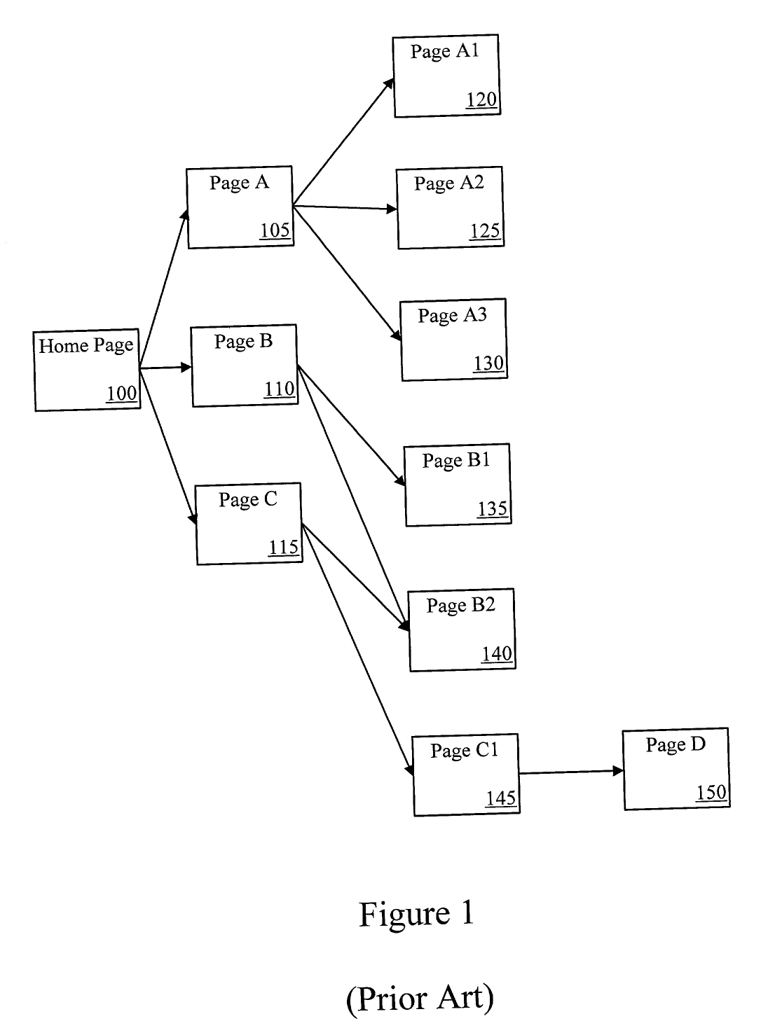

Selecting “Menu for Fun Stuff,” for example, displays the “deepest” web card in a particular web site directly (no navigation of the web site hierarchical structure is required). For example, Page D 150 of FIG. 1 is displayed without navigating through the entire web site hierarchical structure.

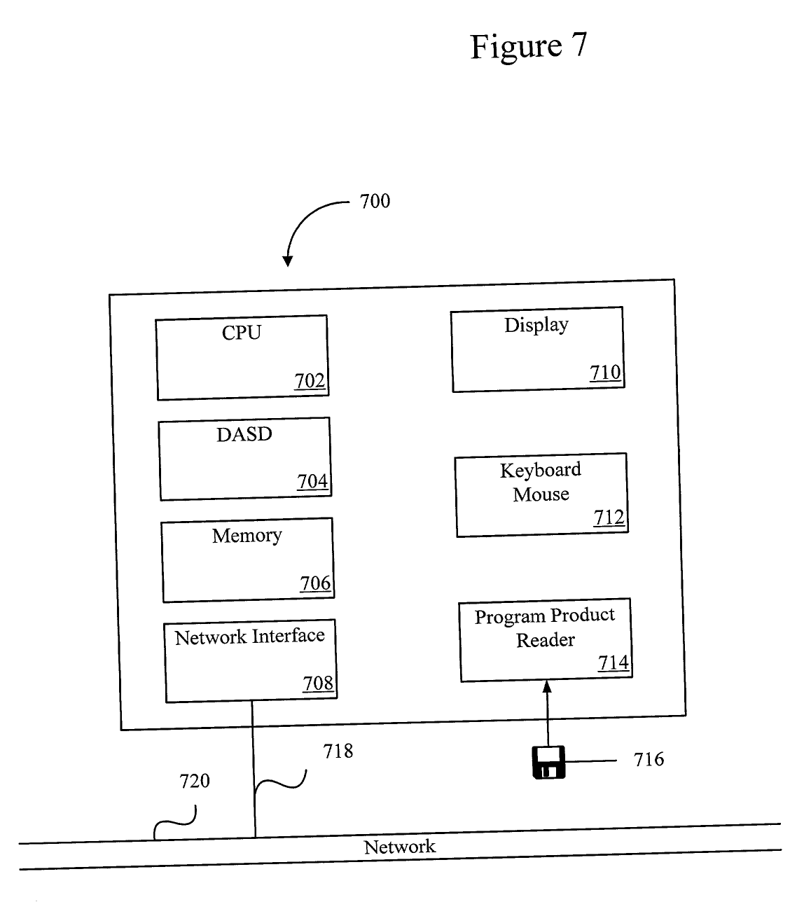

FIG. 7 is a block diagram of an exemplary computer 700 such as might comprise any of the servers or computers (e.g., configuration web server 204 and card web server 216 illustrated in FIG. 2). Each computer 700 operates under control of a central processor unit (CPU) 702, such as a “Pentium” microprocessor and associated integrated circuit chips, available from Intel Corporation of Santa Clara, Calif., USA. A computer user can input commands and data from a keyboard, mouse, and voice and touch screen devices 712 and can view inputs and computer output at a display 710. The display is typically a video monitor or flat panel display device. The computer 700 also includes a direct access storage device (DASD) 704, such as a fixed hard disk drive. The memory 706 typically comprises volatile semiconductor random access memory (RAM). Each computer preferably includes a program product reader 714 that accepts a program product storage device 716, from which the program product reader can read data (and to which it can optionally write data). The program product reader can comprise, for example, a disk drive, and the program product storage device can comprise removable storage media such as a floppy disk, an optical CD-ROM disc, a CD-R disc, a CD-RW disc, DVD disc, or the like. Each computer 700 can communicate with the other connected computers over the network 720 through a network interface 708 that enables communication over a connection 718 between the network and the computer.

The CPU 702 operates under control of programming steps that are temporarily stored in the memory 706 of the computer 700. When the programming steps are executed, the pertinent system component performs its functions. Thus, the programming steps implement the functionality of the system components, such as the configuration web server, card web server, and gateway, illustrated in FIG. 2. The programming steps can be received from the DASD 704, through the program product 716, or through the network connection 718. The storage drive 704 can receive a program product, read programming steps recorded thereon, and transfer the programming steps into the memory 706 for execution by the CPU 702. As noted above, the program product storage device can comprise any one of multiple removable media having recorded computer-readable instructions, including magnetic floppy disks, CD-ROM, and DVD storage discs. Other suitable program product storage devices can include magnetic tape and semiconductor memory chips. In this way, the processing steps necessary for operation in accordance with the invention can be embodied on a program product.

Alternatively, the program steps can be received into the operating memory 706 over the network 718. In the network method, the computer receives data including program steps into the memory 706 through the network interface 708 after network communication has been established over the network connection 718 by well-known methods that will be understood by those skilled in the art without further explanation. The program steps are then executed by the CPU 702 to implement the processing of the system as disclosed herein.

While the above embodiment describes a single computer acting as a web server, (e.g., configuration web server or card web server), those skilled in the art will realize that the functionality can be distributed over a plurality of computers.

It should be understood that all of the computers of the systems (particularly, 204 and 216 illustrated in FIG. 2A), preferably have a construction similar to that shown in FIG. 7, so that details described with respect to the FIG. 7 computer 700 will be understood to apply to all computers of the system. Any of the computers can have an alternative construction, so long as they can communicate with the other computers and/or support the functionality described herein.

One skilled in the art will realize that although the examples described herein generally refer to WAP cards being read by a mobile device, other cards, written in other markup language and/or conforming to other protocol specification may be generated by the present invention following the operative steps and logic described herein.

The present invention has been described above in terms of a presently preferred embodiment so that an understanding of the present invention can be conveyed. There are, however, many configurations for which the present invention is applicable. All modifications, variations, or equivalent arrangements and implementations that are within the scope of the attached claims should therefore be considered within the scope of the invention.

Industrial Applicability

Those skilled in the art will recognize that the method and product of the present invention has many industrial applications, particularly with the growing number of requests for Internet resources via mobile devices.

We claim:

1. A method of creating a set of one or more personal web cards by a user to be used or read by mobile devices, the method comprising the steps of:
a) receiving configuration information from said user to define one or more personal web cards and wherein said received configuration information defines said personal web card(s); and
b) storing said configuration information for said personal web card(s) in a data store.

2. A method as defined in claim 1, further comprising:
a) receiving a request from a mobile device for one of said personal web cards.

3. A method as defined in claim 2, further comprising:
a) generating said requested personal web card based on said stored configuration information retrieved from said data store.

4. A method as defined in claim 3, further comprising:
a) presenting said requested personal web card on said mobile device.

5. A method as defined in claim 3 wherein said generated personal web card is written in WML.

6. A method as defined in claim 3 wherein said generated personal web card is written in HDML.

7. A method of creating a set of one or more personal web cards by a user to be used or read by mobile devices, the method comprising the steps of:
a) receiving configuration information from said user to define one or more personal web cards and wherein said received configuration information defines said personal web card(s);
b) generating said personal web card (s) based on said received configuration information; and
c) storing said generated personal web card(s) in a data store.

8. A method as defined in claim 7, further comprising:
a) receiving a request from a mobile device for one of said stored personal web cards.

9. A method as defined in claim 8, further comprising:
a) presenting said requested personal web card on said mobile device.

10. A method as defined in claim 7 wherein said generated personal web card is written in WML.

11. A method as defined in claim 7 wherein said generated personal web card is written in HDML.

12. A method of receiving personal web cards by a mobile device, the method comprising the steps of:
a) sending a request by said mobile device for a predefined personal web card; and
b) presenting said requested personal web card on said mobile device.

13. A method as defined in claim 12, further comprising:
a) selecting one of the menu options in said requested personal card by a user

14. A computer software product for use in a computer system for enabling a user to generate personal web cards comprising:
a) a computer-readable recordable media; and
b) a program of computer-readable instructions executable by the computer system to perform method steps comprising:
i) receiving configuration information from said user to define one or more personal web cards and wherein said received configuration information defines said personal web card(s); and
ii) storing said configuration information for said personal web card(s) in a data store.

15. A computer software product as defined in claim 14 wherein said program perform method steps further comprising:
a) receiving a request from a mobile device for one of said personal web cards.

16. A computer software product as defined in claim 15 wherein said program perform method steps further comprising:
a) generating said requested personal web card based on said stored configuration information retrieved from said data store.

17. A computer software product as defined in claim 16 wherein said generated personal web card is written in WML.

18. A computer software product as defined in claim 16 wherein said generated personal web card is written in HDML.

19. A computer software product for use in a computer system for enabling a user to generate personal web cards comprising:
a) a computer-readable recordable media; and
b) a program of computer-readable instructions executable by the computer system to perform method steps comprising:
i) receiving configuration information from said user to define one or more personal web cards and wherein said received configuration information defines said personal web card(s);
ii) generating said personal web card(s) based on said received configuration information; and
iii) storing said generated personal web card(s) in a data store.

20. A computer software product as defined in claim 19 wherein said program perform method steps further comprising:
a) receiving a request from a mobile device for one of said stored personal web cards.

21. A computer software product as defined in claim 19 wherein said generated personal web card is written in WML.

22. A computer software product as defined in claim 19 wherein said generated personal web card is written in HDML.

23. An apparatus that enables a user to define one or more personal web cards to be read or used by mobile devices, comprising:
a) a central processing unit that can establish communication with a user computer;
b) a storage device;
c) a processor connected to the storage device wherein the storage device stores at least one program component for controlling the processor; and
d) the processor is operative with said program component to:
i) receive configuration information from said user to define one or more personal web cards and wherein said received configuration information defines said personal web card(s); and
ii) store said configuration information for said personal web card(s) in a data store.

24. An apparatus as defined in claim 23 wherein said processor is operative with said program component to further:
a) receive a request from a mobile device for one of said stored personal web cards.

25. An apparatus as defined in claim 24 wherein said processor is operative with said program component to further:
a) generate said requested personal web card based on said stored configuration information retrieved from said data store.

26. An apparatus as defined in claim 25 wherein said generated personal web card is written in WML.

27. An apparatus as defined in claim 25 wherein said generated personal web card is written in HDML.

28. An apparatus that enables a user to define one or more personal web cards to be read or used by mobile devices, comprising:
a) a central processing unit that can establish communication with a user computer;
b) a storage device;
c) a processor connected to the storage device wherein the storage device stores at least one program component for controlling the processor; and
d) the processor is operative with said program component to:
i) receive configuration information from said user to define one or more personal web cards and wherein said received configuration information defines said personal web card(s);
ii) generate said personal web card(s) based on said received configuration information; and
iii) store said generated personal web card(s) in a data store.

29. An apparatus as defined in claim 28 wherein said processor is operative with said program component to further:
b) receive a request from a mobile device for one of said stored personal web cards.

30. An apparatus as defined in claim 28, wherein said stored personal web card is written in WML.

31. An apparatus as defined in claim 28 wherein said stored personal web card is written in HDML.

32. A mobile device that enables a user to receive personal web cards wherein said mobile device
a) sends a request for a predefined personal web card; and
b) presents said requested personal web card on said mobile device.

33. A mobile device as defined in claim 32 wherein said mobile device
a) enables a user to select one of the menu options in said requested personal web card.

34. A system for enabling a user to define one or more personal web cards and enables a mobile device user to request one of said defined personal web cards, the system comprising:
a) a configuration web server wherein said configuration web server provides a configuration web site enabling said user to define one or more personal web cards by entering configuration information;
b) a data store;
c) a personal card generator wherein said personal card generator generates one or more personal web cards based on said configuration information entered by said user; and
d) a card web server wherein said card server serves the personal web card(s) generated.
